(19) United States
(12) Patent Application Publication
(10) Pub. No.: US 2008/0106384 A1
(43) Pub. Date: May 8, 2008

(54) APPARATUS AND METHOD OF OPTIMIZING OUTPUT POWER OF RFID READER

(76) Inventors: Harrsion Byounghyun CHUNG, Daejeon-city (KR); Nae Soo KIM, Daejeon-city (KR); Cheol Sig PYO, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/923,204

(22) Filed: Oct. 24, 2007

(30) Foreign Application Priority Data
Nov. 8, 2006 (KR) 10-2006-0110168

(51) Int. Cl. H04B 7/00

(52) U.S. Cl. 340/10.2

(57) ABSTRACT

Provided are an apparatus and method of optimizing a power output of a radio frequency identification reader (RFID) reader. The apparatus includes a loss measurement unit which measures an interface loss between the RFID reader and an antenna by receiving a signal output from the antenna of the RFID reader, a output power compensation amplifier which amplifies a power output to compensate for the measured interface loss, and an output fixation unit which uniformly maintains a power output of the output power compensation amplifier by storing the output compensated power value.

### CROSS-REFERENCE TO RELATED PATENT APPLICATION

This application claims the benefit of Korean Patent Application No. 10-2006-0110168, filed on Nov. 8, 2006, in the Korean Intellectual Property Office, the disclosure of which is incorporated herein in its entirety by reference.

### BACKGROUND OF THE INVENTION

1. Field of the Invention

The present invention relates to an apparatus and method of optimizing output power of a radio frequency identification (RFID) reader, and more particularly, to an apparatus and method for improving recognition distance and recognition ratio by optimizing output power emitted from an antenna of an RFID reader by adding an output compensation amplifier or attenuator.

2. Description of the Related Art

A radio frequency identification (RFID) system is a contactless recognition system transmitting and processing information about an object and environment over radio frequencies by employing a small tag which is adhered on various objects. An RFID reader recognizes an RFID tag by outputting an electric wave signal via an antenna and receiving a response from the RFID tag that received the electric wave signal.

In a conventional system, the RFID reader uniformly outputs power to an interface between the RFID reader and an antenna, that is, a length of a cable connecting the RFID reader and the antenna. Accordingly, in an actual environment using a relatively long cable, an output power of the antenna is several dB lower than an output of the RFID reader. An RFID tag operates by receiving an RF energy received from the RFID reader. However, when not enough RF energy is received, the RFID tag is unable to properly respond. Thus, a recognition distance and a recognition success rate decrease.

Since the output of the RFID reader is prescribed, the output cannot be recklessly increased. Also, it is inefficient to individually regulate the output of the RFID reader after installing the RFID system in an actual environment. Accordingly, an apparatus and method which can maximize the output of the antenna up to a value that does not exceed a prescribed limit is required by pre-compensating an interface loss between the RFID reader and the antenna.

### SUMMARY OF THE INVENTION

The present invention provides an apparatus and method which optimizes recognition distance and recognition rate of a radio frequency identification (RFID) tag by optimizing a power output of a RFID reader so that the RFID reader is not affected by an interface loss between the RFID reader and an antenna.

According to an aspect of the present invention, there is provided an apparatus for optimizing an output of a radio frequency identification (RFID) reader, the apparatus including: a loss measurement unit which measures an interface loss between the RFID reader and an antenna by receiving a signal outputted from the antenna of the RFID reader; an output compensation amplifier which amplifies a power output to compensate for the measured interface loss; and an output fixation unit which uniformly maintains a power output of the output power compensation amplifier by storing a compensated power output value.

The loss measurement unit may include an input terminal which receives an output signal of the RFID reader by being directly connected to an end of a cable which has been disconnected from the antenna, wherein the cable connects the RFID reader and the antenna during a normal operating state.

The loss measurement unit may include a measuring antenna which receives an output of the antenna, and the antenna emits a signal towards the measuring antenna when the interface loss is measured.

The loss measurement unit may include an external measurer which directly measures the interface loss using a measuring instrument after the cable connecting the RFID reader and the antenna has been disconnected.

According to another aspect of the present invention, there is provided an apparatus for optimizing a power output of a RFID reader, the apparatus including: a high output power RFID reader which provides a power output larger than a prescribed power output of the RFID reader; a loss measurement unit which measures an interface loss between the high output power RFID reader and an antenna; and a reducer which reduces the power output of the high output power RFID reader to the prescribed power output based on the measured interface loss.

The loss measurement unit may include an external measurer which directly measures the interface loss using a measuring instrument after the cable connecting the RFID reader and the antenna has been disconnected.

According to another aspect of the present invention, there is provided a method of optimizing a power output of a RFID reader, the method including: a loss measuring operation which measures an interface loss between the RFID reader and an antenna by receiving a signal outputted from the antenna of the RFID reader; an output power compensation operation which amplifies a power output to compensate for the measured interface loss; and a power output fixing operation which uniformly maintains the amplified power output by storing a compensated power output value.

In the loss measuring operation, the signal may be received by directly connecting one side of a cable in which the antenna is removed, wherein the cable connects the RFID reader and the antenna.

In the loss measuring operation, the antenna may output towards a measuring antenna provided for receiving an output of the antenna.

In the loss measuring operation, the interface loss may be directly measured using a measuring instrument after disconnecting the cable which connects the RFID reader and the antenna during a normal operating state.

According to another aspect of the present invention, there is provided a method of optimizing a power output of a RFID reader, the method including: providing a power output higher than a prescribed power output of a RFID reader by using a high output power RFID reader as the RFID reader; measuring an interface loss between the high output power RFID reader and the antenna; and reducing a power output of the high output power RFID reader to the prescribed power output based on the measured interface loss.

Measuring of the interface loss may include directly measuring the interface loss using a measuring instrument after disconnecting a cable which connects the large output RFID reader and the antenna during a normal operating state.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an apparatus for optimizing an output of a radio frequency identification (RFID) reader according to an embodiment of the present invention;

FIG. 2 is a diagram illustrating an apparatus for optimizing an output of a RFID reader according to another embodiment of the present invention;

FIG. 3 is a diagram illustrating an apparatus for optimizing an output of a RFID reader according to another embodiment of the present invention;

FIG. 4 is a diagram illustrating an apparatus for optimizing an output of a RFID reader according to another embodiment of the present invention;

FIG. 5 is a flowchart illustrating a method of optimizing an output of a RFID reader according to an embodiment of the present invention; and

FIG. 6 is a flowchart illustrating a method of optimizing an output of a RFID reader according to another embodiment of the present invention.

### DETAILED DESCRIPTION OF THE INVENTION

Hereinafter, the present invention will be described more fully with reference to the accompanying drawings, in which exemplary embodiments of the invention are shown.

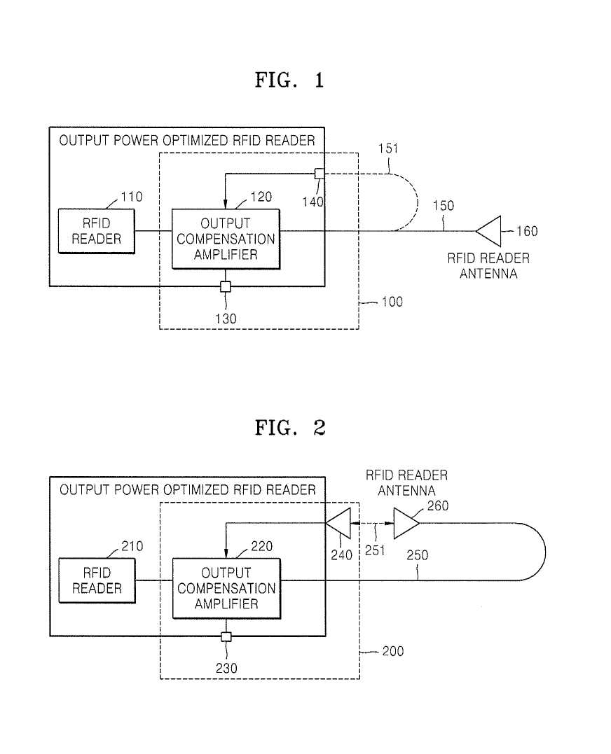

FIG. 1 is a diagram illustrating an apparatus for optimizing an output of a radio frequency identification (RFID) reader according to an embodiment of the present invention.

Referring to FIG. 1, an optimization apparatus 100 includes a loss measurement unit 140 including an input terminal, an output power compensation amplifier 120 and output fixation unit 130.

In a practical application environment, in order to optimize a power output of the antenna 160, an interface loss between the RFID reader 110 and the antenna 160 should be compensated. The interface loss between the RFID reader 110 and the antenna 160 can be up to several dB in an UHF band and a higher frequencies band.

When an output of the RFID reader 110 is recklessly increased in the case where the length of an interface is short, the power output is outside a prescribed value, and thus only a power output increased up to the maximum limit that is within the prescribed value should be transmitted to the antenna 160. Accordingly, the power output of the RFID reader 110 should be increased by an amount which is the same the interface loss. Thus, a constitution that can measure the interface loss, and a constitution that can compensate the measured interface loss are required.

The loss measurement unit 140 receives a signal outputted from the antenna 160 of the RFID reader 110 and measures the interface loss between the RFID reader 110 and the antenna 160.

Preferably, the cable 150 connecting the optimization apparatus 100 and the antenna 160 is disconnected from the antenna 160. Then the end of the cable 150 is connected to the loss measurement unit 140 to receive the output signal of the RFID reader 110 via an alternative cable path 151.

The output compensation amplifier 120 amplifies the power output to compensate for the measured interface loss. That is, the output compensation amplifier 120 compensates the power output by an amount which is the same as the interface loss in order to optimize the power output. That is, in FIG. 1, the interface loss is compensated by amplifying the power output by using the cable 150 to form a feedback loop.

The output fixation unit 130 uniformly maintains an output of the output compensation amplifier 120 by storing the final compensated output value. When the formed feedback loop is removed while the power output of the output compensation amplifier 120 is not fixed to the compensated power output, the power output of the amplifier 120 returns to an initial value, and thus the measuring and amplifying processes become meaningless. Accordingly, the compensated power output is maintained using the output fixation unit 130.

FIG. 2 is a diagram illustrating an apparatus for optimizing an output of a RFID reader according to another embodiment of the present invention.

Referring to FIG. 2, an optimization apparatus 200 for optimizing the power output includes a loss measurement unit 240 including a measuring antenna arranged with respect to an antenna 260 of the RFID reader 210, an output compensation amplifier 220 and an output fixation unit 230. Functions of the loss measurement unit 240, the output compensation amplifier 220 and the output fixation unit 230 have been described with reference to FIG. 1.

In detail, FIG. 2 illustrates an embodiment wherein the loss is measured using the measuring antenna. Preferably, while measuring an interface loss, the antenna 260 is arranged so as to emit a signal towards the measuring antenna. At this time, the antenna 260 and the measuring antenna are connected via an air interface 251. That is, the output of the RFID reader 210 is fed back via the air interface connection.

FIG. 3 is a diagram illustrating an apparatus for optimizing an output of a RFID reader according to another embodiment of the present invention.

Referring to FIG. 3, an optimization apparatus 300 for optimizing the output includes a loss measurement unit 340 including an external measurer, an output compensation amplifier and an output fixation unit 330. Functions of the loss measurement unit 340, the output compensation amplifier 320 and the output fixation unit 330 have been described with reference to FIG. 1.

In detail, FIG. 3 illustrates an embodiment wherein the interface loss between RFID reader 310 and the antenna 360 is measured by the external measurer. Preferably, the interface loss can be measured by directly connecting the external measurer using cables 351 and 352 after disconnecting a cable 350.

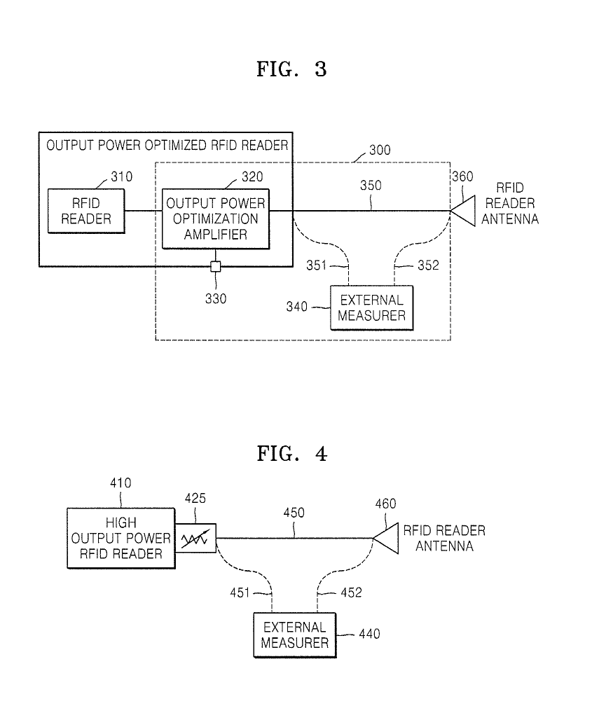

FIG. 4 is a diagram illustrating an apparatus for optimizing an output of a RFID reader according to another embodiment of the present invention.

Referring to FIG. 4, the apparatus includes a high output power RFID reader 410, a loss measurement unit 440 including an external measurer, and a reducer 425.

First, the high output power RFID reader 410 provides an output power larger than a prescribed power output of a general RFID reader.

Then, an interface loss between the high output power RFID reader 410 and an antenna 460 is measured. Preferably, the interface loss between the high output power RFID reader 410 and the antenna 460 is measured by directly connecting cables 451 and 452 of the external, after disconnecting a cable 450.

The reducer 425 reduces the output power of the high output power RFID reader 410 to the prescribed output power based on the measured interface loss. As described above, if the output of the RFID reader is recklessly increased when a length of an interface is short, the output power exceeds the prescribed limit. Accordingly, the power output increased to a level which is as high as possible without exceeding the prescribed limit should be applied to the antenna 460. Thus, the power output of the high output power RFID reader 410 that is above the prescribed limit is reduced to the prescribed power output using the reducer 425.

As described above, when an interface loss between an RFID reader and an antenna is compensated, energy transmitted to an electric tag is also compensated. Accordingly, tag recognition distance and recognition ratio are improved.

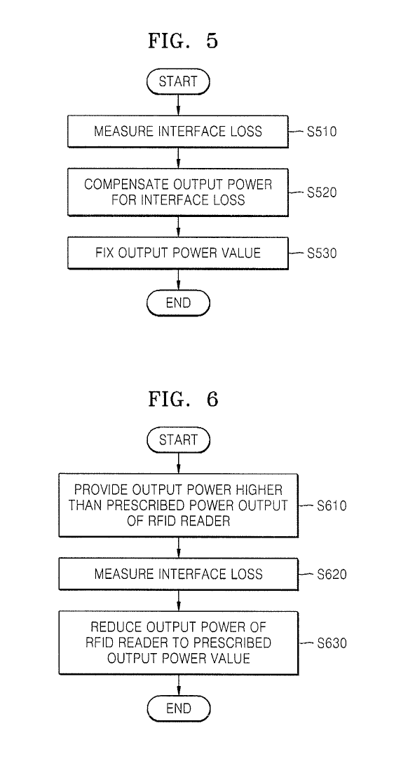

FIG. 5 is a flowchart illustrating a method of optimizing a power output of a RFID reader according to an embodiment of the present invention. The method can be applied to the apparatuses illustrated in FIGS. 1 through 3, and the method will be described with reference to FIGS. 1 through 3.

Referring to FIG. 5, the loss measurement unit 140 measures an interface loss between the RFID reader 110 and the antenna 160 by receiving a signal outputted from the antenna of the RFID reader in operation S510.

Preferably in operation S510, the signal can be received by disconnecting the cable 150 from the antenna 160 and then directly connecting the cable 150 to the input terminal 140 via an alternative cable path 151.

In operation S510, preferably, the interface loss can be measured by the measuring antenna.

In operation S510, preferably, the interface loss can be directly measured using the external measurer after disconnecting the cable 350.

Then, the output compensation amplifier 120 amplifies the output power to a value for compensating the measured interface loss in operation S520.

Finally, In operation S540, the output fixation unit 130 uniformly maintains the output power of the output compensation amplifier 120 by storing the compensated output power.

FIG. 6 is a flowchart illustrating a method of optimizing an output power of a RFID reader according to another embodiment of the present invention. The method can be applied to the apparatus illustrated in FIG. 4, and the method will be described with reference to FIG. 4.

Referring to FIG. 6, the high output power RFID reader 410 provides an output power higher than the prescribed output power of a general RFID reader in operation S610.

In operation S620, an interface loss between the high output power RFID reader 410 and the antenna 460 is measured. Preferably, the interface loss is measured using the external measurer 440 after the cable 450 which connects the high output power RFID reader 410 and the antenna 460 has been disconnected.

Finally, in operation S630, the reducer 425 reduces the output power of the high output power RFID reader 410 to the prescribed output power based on the measured interface loss.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, the power output of the RFID reader is optimized so as not to be affected by the interface loss between the RFID reader and an antenna. Accordingly, recognition distance and recognition ratio of the RFID tag is increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for optimizing an output of a radio frequency identification (RFID) reader, the apparatus comprising:
a loss measurement unit which measures an interface loss between the RFID reader and an antenna by receiving a signal outputted from the antenna of the RFID reader;
an output compensation amplifier which amplifies a power output to compensate for the measured interface loss; and
an output fixation unit which uniformly maintains a power output of the output power compensation amplifier by storing a compensated power output value.

2. The apparatus of claim 1, wherein the loss measurement unit comprises an input terminal which receives an output signal of the RFID reader by being directly connected to an end of a cable which has been disconnected from the antenna, wherein the cable connects the RFID reader and the antenna during a normal operating state.

3. The apparatus of claim 1, wherein the loss measurement unit comprises a measuring antenna which receives an output of the antenna, and the antenna emits a signal towards the measuring antenna when the interface loss is measured.

4. The apparatus of claim 1, wherein the loss measurement unit comprises an external measurer which directly measures the interface loss using a measuring instrument after the cable connecting the RFID reader and the antenna has been disconnected.

5. An apparatus for optimizing a power output of a RFID reader, the apparatus comprising:
a high output power RFID reader which provides a power output larger than a prescribed power output of the RFID reader;
a loss measurement unit which measures an interface loss between the high output power RFID reader and an antenna; and
a reducer which reduces the power output of the high output power RFID reader to the prescribed power output based on the measured interface loss.

6. The apparatus of claim 5, wherein the loss measurement unit comprises an external measurer which directly measures the interface loss using a measuring instrument after the cable connecting the RFID reader and the antenna has been disconnected.

7. A method of optimizing a power output of a RFID reader, the method comprising:
a loss measuring operation which measures an interface loss between the RFID reader and an antenna by receiving a signal outputted from the antenna of the RFID reader;
an output power compensation operation which amplifies a power output to compensate for the measured interface loss; and
a power output fixing operation which uniformly maintains the amplified power output by storing a compensated power output value.

8. The method of claim 7, wherein in the loss measuring operation, the signal is received by directly connecting one side of a cable in which the antenna is removed, wherein the cable connects the RFID reader and the antenna.

9. The method of claim 7, wherein in the loss measuring operation, the antenna outputs towards a measuring antenna provided for receiving an output of the antenna.

10. The method of claim 7, wherein in the loss measuring operation, the interface loss is directly measured using a measuring instrument after disconnecting the cable which connects the RFID reader and the antenna during a normal operating state.

11. A method of optimizing a power output of a RFID reader, the method comprising:
providing a power output higher than a prescribed power output of a RFID reader by using a high output power RFID reader as the RFID reader;
measuring an interface loss between the high output power RFID reader and the antenna; and
reducing a power output of the high output power RFID reader to the prescribed power output based on the measured interface loss.

12. The method of claim 11, wherein measuring of the interface loss comprises directly measuring the interface loss using a measuring instrument after disconnecting a cable which connects the large output RFID reader and the antenna during a normal operating state.
